(19) United States
(12) Patent Application Publication
(10) Pub. No.: US 2019/0084196 A1
(43) Pub. Date: Mar. 21, 2019

(54) NON-WOVEN MATERIALS FOR FOOTWEAR APPLICATIONS

(71) Applicant: Voxel8, Inc., Somerville, MA (US)

(72) Inventors: Travis Alexander Busbee, Somerville, MA (US); Nicholas Burtt Holmes, Hudson, NH (US)

(73) Assignee: Voxel8, Inc., Somerville, MA (US)

(21) Appl. No.: 15/973,938

(22) Filed: May 8, 2018

Related U.S. Application Data
(60) Provisional application No. 62/503,255, filed on May 8, 2017.

(51) Int. Cl. B29C 41/08; B29C 41/52; B29C 41/36

(52) U.S. Cl. CPC B29C 41/08; B32B 3/02; B29C 41/365; B29C 41/52

(57) ABSTRACT

The present disclosure is related to articles for use in footwear and other applications, and associated systems and methods. Certain embodiments relate to methods for producing articles, such depositing a fiber onto a last to form non-woven materials. The fiber may be, for example, a pre-formed fiber, or a fiber that includes a reaction product of a composition extruded from one or more nozzles. In some embodiments, a method may comprise using one or more nozzles to deposit a fiber to form a non-woven material and to 3D-print one or more features onto the non-woven material. In some cases, articles may be formed that include fewer than five pieces of material. In some embodiments, an article may include a non-woven material that comprises thermoset fibers. In addition, some embodiments relate to lasts that may be suited to forming non-woven materials.

### RELATED APPLICATIONS

This application claims priority under 35 U.S.C. § 119(e) to U.S. Provisional Application No. 62/503,255, filed May 8, 2017, and entitled “Non-Woven Materials for Footwear Applications,” which is incorporated herein by reference in its entirety for all purposes.

### FIELD

The present invention relates generally to articles such as non-woven materials for use in footwear and other applications, and associated systems and methods.

### BACKGROUND

Footwear is typically mass produced in large batches and with the use of complex supply chains. Individual articles of footwear produced by typical processes may include numerous standardized pieces that are adhered together and/or stitched together along seams. The standardized pieces may make customizing the footwear for specific users and/or applications challenging, and the seams may reduce the comfort of the footwear.

Accordingly, improved articles for use in footwear that include fewer seams and methods for fabricating articles for use in footwear that include fewer seams may be advantageous.

### SUMMARY

The present invention generally relates to systems and methods involving non-woven materials for use in footwear. The present subject matter of the present invention involves, in some cases, interrelated products, alternative solutions to a particular problem, and/or a plurality of different uses of one or more systems and/or articles.

In one set of embodiments, footwear articles are provided. A footwear article may comprise a non-woven material comprising thermoset fibers. In some embodiments, at least a portion of the thermoset fibers are chemically bonded together. In some embodiments, the non-woven material consists of less than five pieces of fabric joined together by seams to form the non-woven material.

In another set of embodiments, methods of forming articles for use in footwear are described. In some embodiments, a method of forming an article for use in footwear may comprise passing one or more pre-formed fibers through a binder to form one or more binder-coated fibers and depositing the binder-coated fibers onto a last to form a non-woven material.

In some embodiments, a method of forming an article for use in footwear may comprise extruding a composition from a nozzle comprising a first species comprising a first functional group and a second species comprising a second functional group reactive with the first functional group, forming a fiber comprising a reaction product of the first species and the second species, and depositing the fiber onto a footwear last to form a non-woven material.

In some embodiments, a method of forming an article for use in footwear may comprise extruding a composition from a nozzle comprising a first species comprising a first functional group and a second species comprising a second functional group reactive with the first functional group, forming a fiber comprising a reaction product of the first species and the second species, and depositing the fiber onto a target to form a non-woven material.

In some embodiments, a method of forming an article may comprise forming a fiber by extruding a first composition from a nozzle, depositing the fiber onto a target to form a non-woven material, and forming a 3D-printed feature on the non-woven material by 3D-printing a second composition from the nozzle.

In another set of embodiments, footwear lasts are provided. In some embodiments, a footwear last may comprise a portion with a shape substantially corresponding to a shape of a human foot, and a protrusion disposed on the portion with the shape substantially corresponding to the shape of the human foot.

In some embodiments, a footwear last may comprise a portion a portion with a shape substantially corresponding to a shape of a human foot. The portion substantially corresponding to the shape of the human foot may be stably rotated around at least a first axis and a second axis separate from the first axis.

Other advantages and novel features of the present invention will become apparent from the following detailed description of various non-limiting embodiments of the invention when considered in conjunction with the accompanying figures.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 illustrates a method of forming an article for use in footwear from one or more pre-formed fibers, according to some embodiments;

FIG. 2 illustrates a method of forming an article for use in footwear from one or more fibers that are reaction products of a first species and a second species, according to some embodiments;

FIGS. 3A-3C illustrate a method of forming an article for use in footwear by depositing one or more fibers onto a target to form a non-woven material, printing a feature onto the non-woven material, and optionally depositing one or more fibers onto the printed feature, according to some embodiments;

FIG. 3D illustrates a 2.5D feature;

FIG. 3E illustrates a 3D feature;

FIG. 4A illustrates a footwear last, according to some embodiments;

FIG. 4B illustrates a footwear last that can be stably rotated around at least a first axis and a second axis separate from the first axis, according to some embodiments;

FIG. 4C illustrates a footwear last comprising a protrusion, according to some embodiments;

FIG. 5 illustrates a non-woven material consisting of two pieces of fabric, according to some embodiments;

FIG. 6 illustrates a non-woven material comprising fibers that are biaxially aligned, according to some embodiments;

FIGS. 7A-7B illustrate non-woven materials, according to some embodiments;

FIGS. 8A-8B show a process for forming a non-woven material and a non-woven material, according to some embodiments;

FIG. 9 shows a non-woven material, according to some embodiments; and

FIGS. 10A-10B show a body structure that may be stably rotated around a first axis and stably rotated around a second axis separate from the first axis, according to some embodiments.

### DETAILED DESCRIPTION

The present disclosure is related to articles for use in footwear and other applications, and associated systems and methods. Certain embodiments relate to methods for producing articles, such depositing a fiber onto a last to form a non-woven material. The fiber may be, for example, a pre-formed fiber, or a fiber that includes a reaction product of a composition extruded from one or more nozzles. In some embodiments, a method may comprise using one or more nozzles to deposit a fiber to form a non-woven material and to 3D-print one or more features onto the non-woven material. In some cases, articles may be formed that include fewer than five pieces of material. In some embodiments, an article may include a non-woven material that comprises thermoset fibers. In addition, some embodiments relate to lasts that may be suited to forming non-woven materials.

Certain embodiments relate to methods and articles that may be used to form articles for footwear or other applications, e.g., with one or more advantageous properties as described herein. A method may comprise depositing one or more fibers onto a target to form a non-woven material. In some embodiments, the fibers may comprise pre-formed fibers, such as fibers which do not undergo any appreciable change (or which undergo relatively minor changes) in structure during deposition. For example, pre-formed fibers may be passed through a binder before being deposited onto the target, and the binder may adhere the pre-formed fibers together after deposition. Pre-formed fibers may be relatively strong, and so may be capable of being pulled by a target with significant force without undergoing substantial damage. In some embodiments, the fibers may comprise fibers formed during deposition. The fibers may be formed in some cases from a composition comprising at least two species that react to form a reaction product, and/or may be formed by solidifying a melt, solution, or dispersion to form the fibers. The chemical make-up and/or structure of fibers formed during the deposition step may be changed during the deposition step by, for example, changing the chemical make-up of the melt, solution, dispersion, or composition from which the fibers form. The structure of the fibers may be changed during the deposition step, for example, by changing one or more of the physical parameters present during fiber formation, such as the distance between a nozzle from which the precursor to the fibers is extruded and the target on which the fibers are deposited, the rate of fiber deposition, the rate and direction of motion of the nozzle with respect to the target, the chemical make-up of the composition being extruded to form the fibers, and/or the amount of time the deposited fibers are cured, etc. Changes in fiber structure may include changes in fiber diameter, changes in the fiber stiffness, and/or changes in the color of the fibers. In this manner, a non-woven material can be formed in certain embodiments that has spatially-varying properties, such as properties that vary through the thickness of the non-woven material, along the length of the non-woven material, and/or along the width of the non-woven material. Non-woven materials formed in this manner may be customizable for specific users and/or applications (for example, for footwear), and/or may be designed so that each portion of the article has the optimal properties for that portion.

In some embodiments, a method may comprise 3D-printing one or more features onto a non-woven material. For example, a non-woven material may be formed by extruding a first composition from a nozzle to form one or more fibers that are deposited onto a target to form a non-woven material, and then one or more features may be 3D-printed onto the non-woven material. In some, but not necessarily all, cases, a single nozzle may be used to both form the fiber(s) and 3D-print the 3D-printed feature. The use of a single nozzle may be advantageous for one or more reasons, such as allowing for the use of simpler systems with fewer components and/or reducing the amount of time required for footwear article fabrication by allowing multiple components to be fabricated in a single system. However, in other embodiments, more than one nozzle can be used, e.g., instead of a single nozzle.

Articles and methods related to footwear articles comprising non-woven materials are generally provided in other aspects, e.g., as discussed herein. In some embodiments, an article may include a non-woven material that comprises thermoset fibers that are chemically bonded together. The fibers may be bonded together by covalent bonds, and/or may be bonded together by at least one type of bond that is also found within the interior of the fibers (such as a bond that holds the fibers together). Thermoset fibers that are bonded together may have one or more advantageous properties in comparison to thermoplastic fibers, such as enhanced resistance to solvents, higher strength, higher resiliency, and the like.

In some embodiments, an article may be formed from relatively few pieces of material (e.g., non-woven materials). The article may be formed by joined non-woven and/or other materials that are joined together in relatively few places, and/or formed by joined non-woven and/or other materials that may be joined together with seams that extend a relatively short distance. In some embodiments, the article may not include any seams, or may include seams that are unnoticeable to an observer. In some embodiments, an article may include a non-woven material that contains zero seams. Such articles are typically, but not always, formed from a single piece of non-woven material. Such articles formed from relatively few pieces of fabric, containing relatively few seams, and/or containing seams that extend relatively short distances may, in some cases, be used in wearable articles such as shoes, which may enhance the comfort of the wearer of the article, e.g., due to the lack of seams. The articles may be formed by few processes (e.g., fewer than five processes, a single process) and/or require limited assembly, reducing manufacturing complexity. Such materials and articles (for instance, for use in footwear or other applications) may be formed using methods of depositing one or more fibers onto a target to form a non-woven material, and/or other methods, e.g., as those described herein.

Some embodiments discussed herein relate to lasts, which may be suitable for use as targets onto which fibers may be deposited to form non-woven materials. In some embodiments, a last may comprise a portion with a shape substantially corresponding to the shape of a human foot, e.g., the last may be a footwear last. Fibers deposited onto a portion of a last may form a non-woven fabric suitable for use in various applications, such as footwear applications. In some embodiments, the footwear last further comprises one or more protrusions disposed on the portion with the shape substantially corresponding to the shape of the human foot. Fibers deposited onto the protrusion may be form a portion of the non-woven fabric that forms a geometry of interest for a footwear article, such as a wrap-around tongue, a fold-over toe cap, a heel counter, a toe box, and/or other features including those described herein. In addition, other lasts with different shapes may be used in other embodiments, e.g., lasts to form other body parts (e.g., a hand, a knee, an elbow, or the like), or for other applications (e.g., to form articles that are not worn by a subject).

In some embodiments, the portion with the shape substantially corresponding to the shape of the human foot may be stably rotated around at least a first axis and a second axis separate from the first axis. This may allow a first portion of a non-woven material to be formed while rotating the last around the first axis and a second portion of the non-woven material to be formed while rotating the last around the second axis, and/or may facilitate the formation of a non-woven material including fibers oriented in different directions.

As described above, certain embodiments relate to methods for forming articles for use in footwear, or other applications. In some embodiments, the methods may relate to forming non-woven materials, such as non-woven materials comprising fibers that are chemically bonded together. In some embodiments, the methods may comprise extruding one or more materials from a nozzle and/or depositing one or more fibers onto a target, such as a last. It should be understood that any of the methods described herein may include the use of multiple nozzles in some embodiments, and that each nozzle may be capable, in certain cases, of being independently translated with respect to the target, and/or rotated around the target. Similarly, in some cases, the target may be capable of being rotated around one or more axes and or of being translated with respect to the nozzle(s). A combination of these may also be used in some cases. Without wishing to be bound by any theory, it is believed that varying the relative motion of the nozzle(s) with respect to the target and/or of the target with respect to the nozzle may cause variation in the orientation at which the fiber(s) are deposited onto the target, which may allow desirable fiber orientations, such as biaxial orientations and/or loops, to be obtained. For example, in some embodiments, a target such as a last may be rotated to create fiber loops, which may be suitable for use as eyelets in footwear or other articles. As another example, fibers may be deposited that are substantially aligned along one direction.

It should also be noted that any targets described herein may have any suitable structure. In some embodiments, the target may be a target that is substantially non-planar, such as a target with a shape substantially corresponding to the shape of a human foot and/or a target that is a footwear last. In some embodiments, the non-woven material may conformally cover at least a portion of the target, or may conformally cover the entirety of the target. Other examples of targets or lasts are discussed elsewhere herein.

Some embodiments relate to forming articles for use in footwear (or other applications) by forming a non-woven material from one or more pre-formed fibers. (It should be understood, however, that in other embodiments, fibers may be synthesized and used relatively quickly after formation, e.g., as discussed herein.) Pre-formed fibers may include fibers that do not undergo any appreciable structural or chemical changes during formation of the non-woven material. The fibers may be kept to temperatures below their melting point, glass transition temperature, or softening point. In some cases, the fibers may be prevented from being exposed to a solvent in which they would dissolve, and/or exposed to a condition that would trigger a chemical reaction while the non-woven material is being formed. In some embodiments, a non-woven material is formed from fibers that are passed through a binder to form binder-coated fibers, and/or from a method comprising depositing the binder-coated fibers onto a target. The fibers may be pre-formed fibers, and/or may be formed just before passing through the binder.

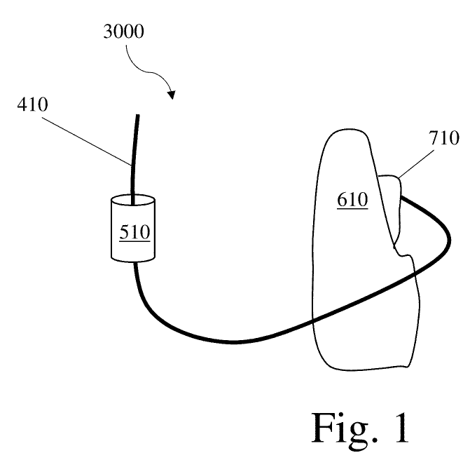

FIG. 1 shows an example of a method 3000 in which fibers 410 are passed through binder 510 and deposited onto target 610 to form non-woven material 710. In some embodiments, one or more pre-formed fibers may be unwound from a spool or other source of fiber prior to passing through the binder. In some embodiments, one or more fibers may pass through a structure that positions the fibers to deposit onto the target at a desired angle prior to, after, or simultaneously with passing through the binder, such a fiber guide (not shown in FIG. 1).

If used, any suitable pre-formed fibers may be employed. The pre-formed fibers may be separated fibers or may be in the form of bundles, such as bundles formed by a spinneret. In some cases, bundled fibers may have improved strength and/or toughness in comparison to unbundled fibers. The pre-formed fibers may comprise thermoplastics and/or thermosets. In some embodiments, the pre-formed fibers comprise one or more of nylon fibers, polyester fibers, thermoplastic polyurethane fibers, polyester-polyurethane copolymer fibers, Spandex fibers, poly(tetrafluoroethylene) fibers, and Gore-Tex fibers. In addition, as noted above, in some cases, non-pre-formed fibers may be used, e.g., in addition to and/or instead of pre-formed fibers.

Any suitable binder may be employed. In some embodiments, the binder comprises one or more of a one-part adhesive, a two-part adhesive, a water-based adhesive, a UV-curable adhesive, a hot melt adhesive, a moisture curing adhesive, and a heat-curable adhesive (e.g., a one-part heat-curable adhesive). In some cases, the binder allows two or more fibers to become bound together, e.g., physically and/or chemically. In some cases, the bound fibers may define a fabric or a non-woven material.

In some embodiments, an article for use in footwear (or in other applications) may be formed by forming a fiber from a composition that comprises a first species and a second species that are capable of undergoing a chemical reaction to form a reaction product. The first species may comprise a first functional group that is reactive with a second functional group of the second species. In some embodiments, both the first species and the second species may be incorporated into the reaction product, and/or the reaction product may comprise at least a portion of the first species and at least a portion of the second species. In other embodiments, at least one of the first species and the second species may not be incorporated into the reaction product. For instance, the second species may be a catalyst that promotes reaction of the first species with itself or with another species to form the reaction product.

When a composition comprises at least a first species and a second species, a ratio of the weight of the first species to the weight of the second species in the composition may be any suitable value. In some embodiments, the ratio of the weight of the first species to the weight of the second species in the composition is greater than or equal to 1, greater than or equal to 2, greater than or equal to 5, greater than or equal to 10, greater than or equal to 20, or greater than or equal to 50. In some embodiments, the ratio of the weight of the first species to the weight of the second species in the composition is less than or equal to 100, less than or equal to 50, less than or equal to 20, less than or equal to 10, less than or equal to 5, or less than or equal to 2. Combinations of the above-referenced ranges are also possible (e.g., greater than or equal to 1 and less than or equal to 100). Other ranges are also possible.

In some embodiments, the composition may further comprise one or more components that are not the first species or the second species, and/or are not reactive with the first species and/or the second species. Non-limiting examples of such components include pigments, dyes, catalysts, UV stabilizers, and rheological modifiers.

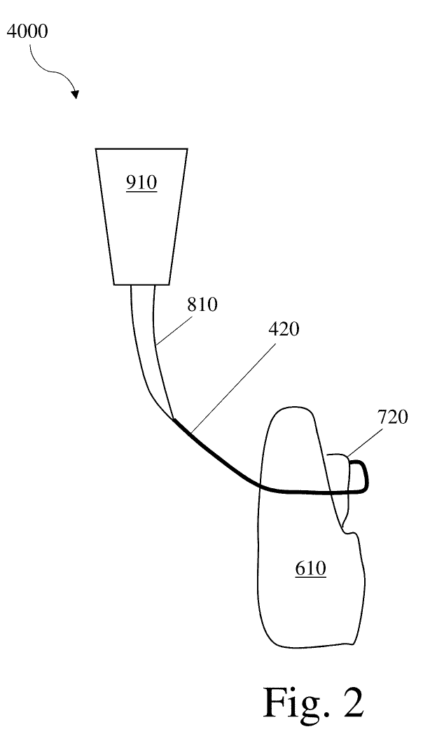

A composition employed to form one or more fibers may be extruded from a nozzle (or more than one nozzle) to form a fiber that comprises the reaction product and that is deposited onto a target, such as a last. In some embodiments, the first species and the second species may first be exposed to each other in a nozzle, and/or may be mixed together in the nozzle. In some embodiments, the first species and the second species may not be mixed together, but may be extruded together to form a fiber thin enough that diffusion causes sufficient mixing, for example, by using two or more nozzles, or by introducing the species into a nozzle such that substantially no mixing occurs prior to the species leaving the nozzle. Certain embodiments may not make use of a mixing nozzle, and/or may pass compositions that have been previously mixed through a nozzle or mixing nozzle. FIG. 2 shows one non-limiting embodiment of a method 4000 in which composition 810 is extruded from nozzle 910 to form fiber 420, which is deposited onto target 610, e.g., to form non-woven material 720. The reaction product may begin to form or may continue to form at any point during the process for formation of the fiber. For example, the reaction product may begin to form and/or continue to form while the composition is in the nozzle, after the composition has been extruded from the nozzle but prior to fiber formation, and/or after fiber formation. In some embodiments, the reaction product may continually form throughout extrusion, fiber formation, and fiber deposition onto the target. In some embodiments, the reaction product may continue to form after fiber deposition. In other words, at least a portion of the composition may be cured prior to extrusion from the nozzle, at least a portion of the composition may cure during fiber formation, and/or at least a portion of the composition may cure after fiber deposition. Similarly, at least a portion of the composition may be uncured prior to extrusion from the nozzle, at least a portion of the composition may be uncured during fiber formation, and/or at least a portion of the composition may be uncured after fiber deposition. In some embodiments, the fiber formation and/or curing may be activated by exposure to one or more triggers, such as UV light, heat, and/or moisture.

In some embodiments, greater than or equal to 0 wt % of the composition is made up of cured material prior to extrusion from the nozzle, greater than or equal to 1 wt % of the composition is made up of cured material prior to extrusion from the nozzle, greater than or equal to 2 wt % of the composition is made up of cured material prior to extrusion from the nozzle, greater than or equal to 5 wt % of the composition is made up of cured material prior to extrusion from the nozzle, greater than or equal to 10 wt % of the composition is made up of cured material prior to extrusion from the nozzle, greater than or equal to 20 wt % of the composition is made up of cured material prior to extrusion from the nozzle, greater than or equal to 50 wt % of the composition is made up of cured material prior to extrusion from the nozzle, or greater than or equal to 75 wt % of the composition is made up of cured material prior to extrusion from the nozzle. In some embodiments, less than or equal to 90 wt % of the composition is made up of cured material prior to extrusion from the nozzle, less than or equal to 75 wt % of the composition is made up of cured material prior to extrusion from the nozzle, less than or equal to 50 wt % of the composition is made up of cured material prior to extrusion from the nozzle, less than or equal to 20 wt % of the composition is made up of cured material prior to extrusion from the nozzle, less than or equal to 10 wt % of the composition is made up of cured material prior to extrusion from the nozzle, less than or equal to 5 wt % of the composition is made up of cured material prior to extrusion from the nozzle, or less than or equal to 2 wt % of the composition is made up of cured material prior to extrusion from the nozzle. Combinations of the above-referenced ranges are also possible (e.g., greater than or equal to 1 wt % and less than or equal to 90 wt % of the composition is made up of cured material prior to extrusion from the nozzle). Other ranges are also possible.

In some embodiments, greater than or equal to 1 wt % of the composition is made up of cured material after extrusion from the nozzle and prior to fiber formation, greater than or equal to 2 wt % of the composition is made up of cured material after extrusion from the nozzle and prior to fiber formation, greater than or equal to 5 wt % of the composition is made up of cured material after extrusion from the nozzle and prior to fiber formation, greater than or equal to 10 wt % of the composition is made up of cured material after extrusion from the nozzle and prior to fiber formation, greater than or equal to 20 wt % of the composition is made up of cured material after extrusion from the nozzle and prior to fiber formation, greater than or equal to 50 wt % of the composition is made up of cured material after extrusion from the nozzle and prior to fiber formation, or greater than or equal to 75 wt % of the composition is made up of cured material after extrusion from the nozzle and prior to fiber formation. In some embodiments, less than or equal to 90 wt % of the composition is made up of cured material after extrusion from the nozzle and prior to fiber formation, less than or equal to 75 wt % of the composition is made up of cured material after extrusion from the nozzle and prior to fiber formation, less than or equal to 50 wt % of the composition is made up of cured material after extrusion from the nozzle and prior to fiber formation, less than or equal to 20 wt % of the composition is made up of cured material after extrusion from the nozzle and prior to fiber formation, less than or equal to 10 wt % of the composition is made up of cured material after extrusion from the nozzle and prior to fiber formation, less than or equal to 5 wt % of the composition is made up of cured material after extrusion from the nozzle and prior to fiber formation, or less than or equal to 2 wt % of the composition is made up of cured material after extrusion from the nozzle and prior to fiber formation. Combinations of the above-referenced ranges are also possible (e.g., greater than or equal to 1 wt % and less than or equal to 90 wt % of the composition is made up of cured material after extrusion from the nozzle and prior to fiber formation). Other ranges are also possible.

In some embodiments, greater than or equal to 1 wt % of the composition is made up of cured material after fiber formation and prior to fiber deposition, greater than or equal to 2 wt % of the composition is made up of cured material after fiber formation and prior to fiber deposition, greater than or equal to 5 wt % of the composition is made up of cured material after fiber formation and prior to fiber deposition, greater than or equal to 10 wt % of the composition is made up of cured material after fiber formation and prior to fiber deposition, greater than or equal to 20 wt % of the composition is made up of cured material after fiber formation and prior to fiber deposition, greater than or equal to 50 wt % of the composition is made up of cured material after fiber formation and prior to fiber deposition, or greater than or equal to 75 wt % of the composition is made up of cured material after fiber formation and prior to fiber deposition. In some embodiments, less than or equal to 90 wt % of the composition is made up of cured material after fiber formation and prior to fiber deposition, less than or equal to 75 wt % of the composition is made up of cured material after fiber formation and prior to fiber deposition, less than or equal to 50 wt % of the composition is made up of cured material after fiber formation and prior to fiber deposition, less than or equal to 20 wt % of the composition is made up of cured material after fiber formation and prior to fiber deposition, less than or equal to 10 wt % of the composition is made up of cured material after fiber formation and prior to fiber deposition, less than or equal to 5 wt % of the composition is made up of cured material after fiber formation and prior to fiber deposition, or less than or equal to 2 wt % of the composition is made up of cured material after fiber formation and prior to fiber deposition. Combinations of the above-referenced ranges are also possible (e.g., greater than or equal to 1 wt % and less than or equal to 90 wt % of the composition is made up of cured material after fiber formation and prior to fiber deposition). Other ranges are also possible.

In some embodiments, greater than or equal to 1 wt % of the composition is made up of cured material upon fiber deposition, greater than or equal to 2 wt % of the composition is made up of cured material upon fiber deposition, greater than or equal to 5 wt % of the composition is made up of cured material upon fiber deposition, greater than or equal to 10 wt % of the composition is made up of cured material upon fiber deposition, greater than or equal to 20 wt % of the composition is made up of cured material upon fiber deposition, greater than or equal to 50 wt % of the composition is made up of cured material upon fiber deposition, or greater than or equal to 75 wt % of the composition is made up of cured material upon fiber deposition. In some embodiments, less than or equal to 90 wt % of the composition is made up of cured material upon fiber deposition, less than or equal to 75 wt % of the composition is made up of cured material upon fiber deposition, less than or equal to 50 wt % of the composition is made up of cured material upon fiber deposition, less than or equal to 20 wt % of the composition is made up of cured material upon fiber deposition, less than or equal to 10 wt % of the composition is made up of cured material upon fiber deposition, less than or equal to 5 wt % of the composition is made up of cured material upon fiber deposition, or less than or equal to 2 wt % of the composition is made up of cured material upon fiber deposition. Combinations of the above-referenced ranges are also possible (e.g., greater than or equal to 1 wt % and less than or equal to 90 wt % of the composition is made up of cured material upon fiber deposition). Other ranges are also possible.

In some embodiments, one or more properties of the fiber may vary during the extrusion process. For example, the color of the fiber and/or the stiffness of the fiber may vary as the fiber is extruded. Property variation may be achieved by dynamically varying one or more parameters during extrusion, such as the rate of extrusion, the rate of mixing of the composition being extruded, the chemical make-up of the composition being extruded, the distance between the nozzle and the target, and/or the relative motion or rotation of the nozzle and/or target with respect to each other, etc. Non-limiting examples of systems and methods for controlling such properties during formation of a fiber or other systems (for example, in systems such as active mixing systems) may be seen in U.S. Pat. Apl. Ser. No. 62/464,363, entitled “Techniques and Systems for Three-Dimensional Printing of Foam and Other Materials,” filed Feb. 27, 2017, incorporated herein by reference in its entirety.

A composition used to form a fiber comprising a reaction product may comprise any suitable species and functional groups. In some embodiments, the reaction product may be a thermoset. In other embodiments, the reaction product may be a thermoplastic. Non-limiting examples of suitable first and/or second functional groups that can react to form a reaction product include hydroxyl groups, isocyanate groups, amine groups, glycidyl groups, epoxide groups such as cycloaliphatic epoxy groups, vinyl groups, catalysts such as platinum catalysts and tin catalysts, acrylate groups, methacrylate groups, and photoinitiators. For example, a composition comprising a first functional group that is a hydroxyl group and a second functional group that is an isocyanate group may form a reaction product that comprises a urethane bond. As another example, a composition comprising a first functional group that is an amine group and a second functional group that is an isocyanate group may form a reaction product that comprises a urea bond. Other suitable reaction products include reaction products formed from reactions of epoxies, homopolymerizations, addition curing, condensation curing, and/or free radical curing. In some embodiments, the composition may comprise a photoinitiator, and/or may be cure under UV light exposure. For instance, a composition comprising a first functional group that is an acrylate or methacrylate group and a second functional group that is a free radical photoinitiator.

In one set of embodiments, the reaction product includes a polyurethane, e.g., formed by reacting a polyol with an isocyanate. The polyol may be any suitable polyhydroxy compound. For example, the polyol may be a hydroxy-terminated ester, ether or carbonate diol. Non-limiting examples of polyalkylene ether glycols include polyethylene ether glycols, poly-1,2-propylene ether glycols, polytetramethylene ether glycols, poly-1,2-dimethylethylene ether glycols, poly-1,2-butylene ether glycol, and polydecamethylene ether glycols. In some embodiments, the polyol may be a polyalkylene ether glycol with a molecular weight between 200 and 10,000 Da. Examples of polyester polyols include polybutylene adipate and polyethylene terephthalate. Examples of polycarbonate diols include polytetramethylene carbonate diol, polypentamethylene carbonate diol, polyhexamethylene carbonate diol, polyhexane-1,6-carbonate diol and poly(1,6-hexyl-1,2-ethyl carbonate)diol. However, many other suitable polyhydroxy compounds can also be used depending upon the desired application. Any suitable polyol, polythiol or polyamine or mixture thereof that is suitable for this purpose may be used, such as, for example, mixed diols comprising a 2,4-dialkyl-1,5-pentanediol and a 2,2-dialkyl-1,3-propanediol. Specific examples of 2,4-dialkyl-1,5-pentanediols include 2,4-dimethyl-1,5-pentanediol, 2-ethyl-4-methyl-1,5-pentanediol, 2-methyl-4-propyl-1,5-pentanediol, 2,4-diethyl-1,5-pentanediol, 2-ethyl-4-propyl-1,5-pentanediol, 2,4-dipropyl-1,5-pentanediol, 2-isoptopyl-4-methyl-1,5-pentanediol, 2-ethyl-4-isoptopyl-1,5-pentanediol, 2,4-diisopropyl-1,5-pentanediol, 2-isopropyl-4-propyl-1,5-pentanediol, 2,4-dibutyl-1,5-pentanediol, 2,4-dipentyl-1,5-pentanediol, 2,4-dihexyl-1,5-pentanediol, and the like. Specific examples of 2,2-dialkyl-1,3-propanediols include 2,2-dipentyl-1,3-propanediol, 2,2-dihexyl-1,3-propanediol and the like.

Polyols may comprise any number of hydroxyl groups (e.g., one, two, three, or more). In some embodiments, a composition may comprise a mixture of polyols with differing functionalities. For example, the composition may comprise a mixture of diols and triols.

In some cases, longer-chain or higher molecular weight polyols may be used to produce relatively softer materials because they have more polyol relative to isocyanate. In some embodiments, the polyols may have a number average molecular weight of greater than or equal to 200 Da, greater than or equal to 500 Da, greater than or equal to 1,000 Da, greater than or equal to 2,000 Da, or greater than or equal to 5,000 Da. In some embodiments, the polyols may have a number average molecular weight of less than or equal to 10,000 Da, less than or equal to 5,000 Da, less than or equal to 2,000 Da, less than or equal to 1,000 Da, or less than or equal to 500 Da. Combinations of the above-referenced ranges are also possible (e.g., greater than or equal to 200 Da and less than or equal to 10,000 Da). Other ranges are also possible. The number average molecular weight of the polyols may be determined by gel permeation chromatography.

In some cases, the isocyanate can also be underindexed compared to the number of reactive sites on the polyol to make a softer foam that behaves less elastically.

The cross-linking agent, if present, can comprise an isocyanate in some cases, and/or an isocyanate prepolymer. An isocyanate may have more than one functional isocyanate group per molecule and may be any suitable aromatic, aliphatic or cycloaliphatic polyisocyanate. In some cases, the isocyanate is a diisocyanate. One non-limiting example is an organic diisocyanate. Additional examples of organic diisocyanates include 4,4′-diisocyanatodiphenylmethane, 2,4′-diisocyanatodiphenylmethane, isophorone diisocyanate, p-phenylene diisocyanate, 2,6-toluene diisocyanate, polyphenyl polymethylene polyisocyanate, 1,3-bis(isocyanatomethyl)cyclohexane, 1,4-diisocyanatocyclohexane, 1,6-hexamethylene diisocyanate, 1,5-naphthalene diisocyanate, 3,3′-dimethyl-4,4′-biphenyl diisocyanate, 4,4′-diisocyanatodicyclohexylmethane, 2,4′-diisocyanatodicyclohexylmethane, and 2,4-toluene diisocyanate, or combinations thereof.

In some cases, an isocyanate prepolymer may be used, e.g., in addition to and/or instead of an isocyanate. For instance, where two isocyanates are added to the ends of a polyol, so it still has functionality of two, but with a higher molecular weight.

In some embodiments, a crosslinked reaction product (i.e., a thermoset) is formed. In some embodiments, a thermoplastic is formed. As a non-limiting example, a high number-average molecular weight diol may be mixed with an isocyanate (e.g., a diisocyanate, or other isocyanates described herein) and deposited onto a substrate, e.g., to produce a thermoplastic elastomer. In another embodiment, a low number-average molecular weight diol can be mixed with an isocyanate and deposited onto a substrate, e.g., to produce a rigid thermoplastic. In yet another embodiment, a high number-average molecular weight diol and a high number-average molecular weight triol can be mixed, and then the polyol mixture mixed with an isocyanate and deposited onto a substrate, e.g., to produce a flexible thermosetting elastomer with high resiliency.

In some embodiments, the composition may further comprise a polymer with a relatively high molecular weight. The number average molecular weight of the polymer may be greater than or equal to 40,000 Da, greater than or equal to 100,000 Da, greater than or equal to 200,000 Da, greater than or equal to 500,000 Da, greater than or equal to 1,000,000 Da, or greater than or equal to 2,000,000 Da. The number average molecular weight of the polymer may be less than or equal to 5,000,000 Da, less than or equal to 2,000,000 Da, less than or equal to 1,000,000 Da, less than or equal to 500,000 Da, less than or equal to 200,000 Da, or less than or equal to 100,000 Da. Combinations of the above-referenced ranges are also possible (e.g., greater than or equal to 40,000 Da and less than or equal to 5,000,000 Da). Other ranges are also possible. The number average molecular weight of the polymer may be determined by gel permeation chromatography. Without wishing to be bound by any theory, it is believed that the addition of a high molecular weight polymer may promote advantageous extensional properties of the composition, such as being capable of extending without breaking (e.g., extending greater than or equal to 500% without breaking, extending greater than or equal to 1,000% without breaking, extending greater than or equal to 2,000% without breaking, extending greater than or equal to 5,000% without breaking, or extending greater than or equal to 10,000% without breaking). This property may be characterized by pressing two circular plates together around the polymer or composition that comprises the polymer and then moving them apart.

In addition, in some embodiments, other methods of forming an article and/or a non-woven material may be employed. For example, a method may comprise melt spinning fibers onto a target, solution spinning fibers onto a target, and/or dispersion spinning fibers onto a target. It should be understood that unless a particular method of forming the footwear article and/or a non-woven material is specified, descriptions herein should be understood to refer to methods that comprise any or all of these and/or other techniques for fiber formation and non-woven material formation, e.g., to form various articles such as those described herein, including footwear.

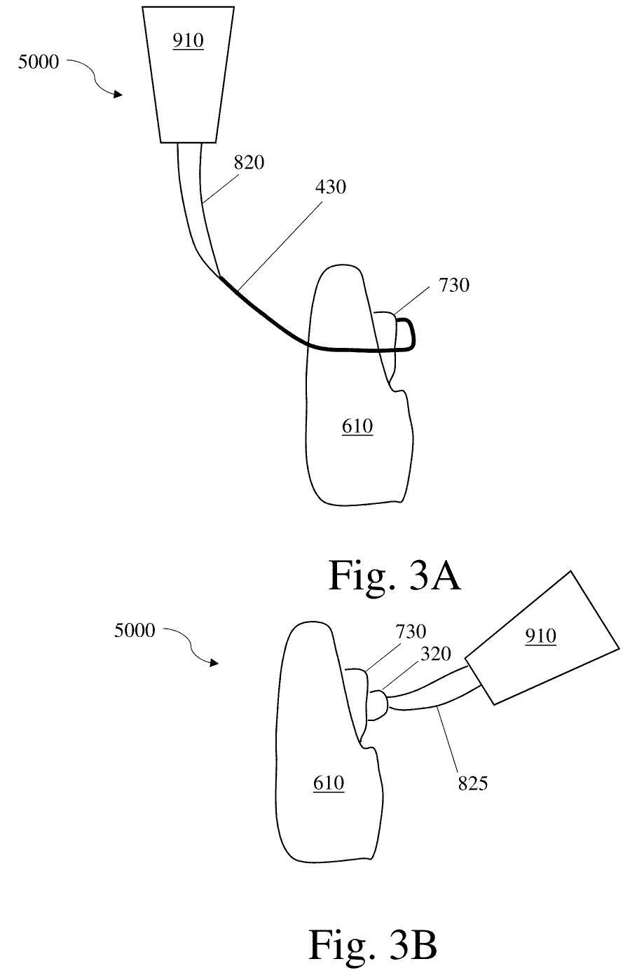

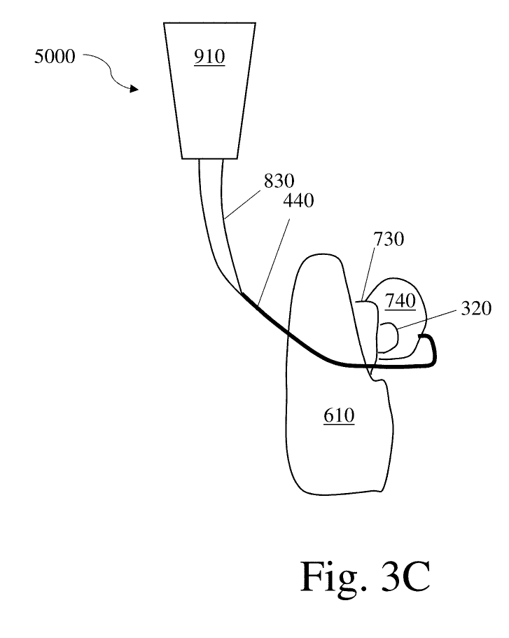

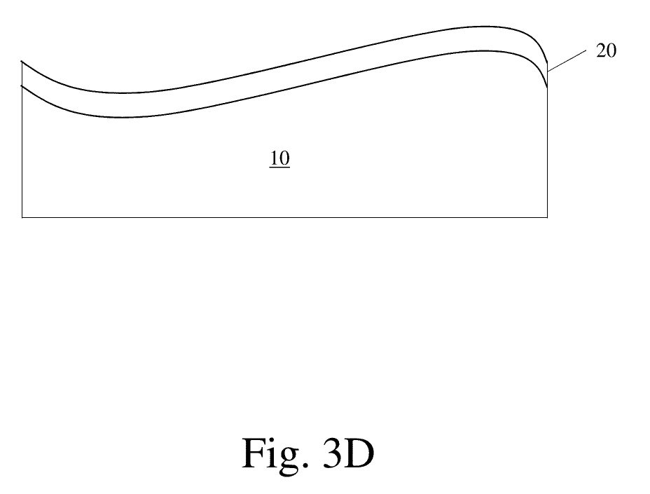

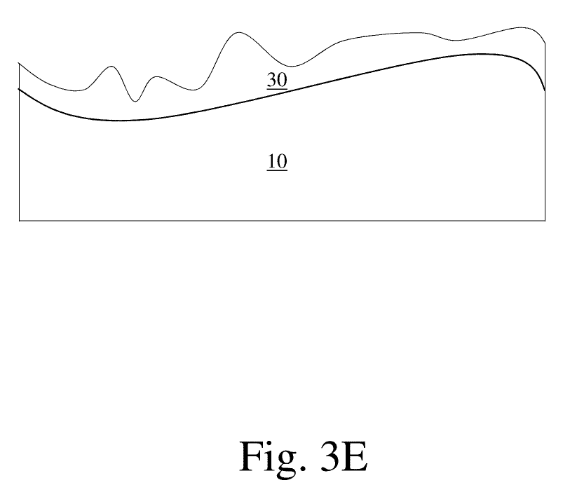

Certain embodiments relate to methods for forming features on non-woven materials or articles. For instance, a feature may be 3D-printed, sprayed, ink jetted, valve jetted, stamped, and/or deposited by injection molding onto an article or a non-woven material as described herein. In some embodiments, the feature may be 3D-printed onto an article or a non-woven material using a nozzle that was also used to form one or more fibers present in the article. As an example, a single nozzle may both extrude a composition that forms a fiber deposited onto a target to form a non-woven material and form a 3D-printed feature on the non-woven material. The 3D-printed feature may be formed by extrusion. FIGS. 3A and 3B show one example of a method 5000 in which first composition 820 is extruded from nozzle 910 to form fiber 430 which is deposited onto target 610 to form non-woven material 730 and then second composition 825 is printed from nozzle 910 to form 3D-printed feature 320. The fiber may be formed by any suitable technique, such as by forming a reaction product between two species in a composition, by melt spinning, by solution spinning, and/or by dispersion spinning. In some embodiments, the 3D-printed feature may have a substantially similar chemical make-up to the article that it is on.

As used herein, a portion that is “on”, “disposed on” or “adjacent” another portion may be directly on the portion such that no intervening portion is present, or one or more intervening portions may be present. A portion that is positioned “between” two portions may be directly between the two portions such that no intervening portion is present, or one or more intervening portions may be present.

In some embodiments, as described above, a method may comprise forming an article using more than one nozzle. For instance, a method may comprise using a first nozzle to form one or more fibers (e.g., by extrusion) and using a second nozzle other than the first nozzle to form one or more other features of the article (e.g., an extrusion nozzle, a spray nozzle, an ink jet nozzle, a valve jet nozzle). The fibers may be formed by any suitable technique, such as by forming a reaction product between two species in a composition, by melt spinning, by solution spinning, and/or by dispersion spinning. In some embodiments, the feature may have a substantially similar chemical make-up to the article that it is on. In other embodiments, the feature may have a different chemical make-up from the article that it is on. The second nozzle may be of the same type as the first nozzle (e.g., it may also be suitable for extruding fibers), or it may be of a different type. In some embodiments, three, four, five, six, or more nozzles may be employed to form an article. Each nozzle may independently be of a unique type (i.e., of a different type than any of the other nozzles employed) or may be of the same type as one or more of the other nozzles employed. Some methods comprise using more than one nozzle, each of which is of the same type. Some methods comprise using more than one nozzle, each of which is of a different type. Non-limiting examples of types of nozzles that may be employed include spray nozzles (e.g., spray atomization nozzles; spray nozzles in fluidic communication with mixing chambers, such as mixing chambers in fluidic communication with two or more input materials), extrusion nozzles, ink jet nozzles, valve jet nozzles, and nozzles described in U.S. patent application Ser. No. 15/907,160, incorporated herein by reference in its entirety.

In some embodiments, one or more fibers may be deposited onto a feature disposed on an article or a non-woven material to form a two (or more) layer material comprising the feature. The feature may be a 3D-printed feature, a sprayed feature, an ink jetted feature, a valve jetted feature, or another suitable type of feature. The feature may be embedded within the article in some instances. The second layer may be deposited after the feature has undergone substantially no curing, has partially cured, or has fully cured. In some embodiments, the feature may be “tacky” when the second non-woven material layer is deposited. FIG. 3C shows an example method in which third composition 830 is extruded from nozzle 910 to form fiber 440 which is deposited onto first non-woven material layer 730 and 3D-printed feature 320 to form second non-woven material layer 740. Although second non-woven material layer 740 is shown as being directly adjacent both first non-woven material layer 730 and 3D-printed feature 320, it should be understood that other geometries may also be possible. For example, the 3D-printed feature may completely or partially cover first non-woven material layer and the second non-woven material layer may be directly adjacent to the 3D-printed feature.

It should be understood that when a method comprises using more than one nozzle, the different nozzles may be used in a variety of suitable orders. Similarly, when a method comprises employing more than one type of deposition method, the deposition methods may be used in a variety of suitable orders. For example, certain methods comprise depositing one or more fibers using a first nozzle (e.g., by extrusion) and then forming one or more features on the deposited fibers (e.g., by extrusion, by spraying, by 3D-printing, by ink jetting, by valve jetting) using a second nozzle. As another example, certain methods comprise forming one or more features using a first nozzle (e.g., by extrusion, by spraying, by 3D-printing, by ink jetting, by valve jetting) and then depositing one or more fibers onto the features using a second nozzle (e.g., by extrusion). As a third example, certain methods comprise depositing one or more fibers using a first nozzle (e.g., by extrusion), forming one or more features on the deposited fibers using a second nozzle (e.g., by extrusion, by spraying, by 3D-printing, by valve jetting), and then depositing one or more fibers onto the features by use of a nozzle (e.g., the first nozzle, the second nozzle, a third nozzle). As a fourth example, certain methods comprise depositing one or more fibers using a first nozzle (e.g., by extrusion), ink jetting one or more features onto the deposited fibers, and then forming one or more features on the ink jetted feature(s) (e.g., by extrusion, by spraying, by 3D-printing, by valve jetting). As a fifth example, certain methods comprise depositing one or more fibers using a first nozzle, forming one or more features on the deposited fibers (e.g., by extrusion, by spraying, by 3D-printing, by valve jetting), and then ink jetting one or more feature(s) on the previously-formed feature(s). In some embodiments, a further feature may be formed on the ink jetted feature(s) (e.g., a 3D-printed feature, a sprayed feature, a valve jetted feature).

Prior to forming a feature on a target (e.g., a non-woven material), an adhesive may be deposited on the target (e.g., by a nozzle used to form the feature, by a nozzle used to form the non-woven material, by a nozzle used neither to form the non-woven material nor the feature).

Fiber(s) deposited onto a feature may be formed by any suitable technique, such as by forming a reaction product between two species in a composition, by melt spinning, by solution spinning, and/or by dispersion spinning. Non-limiting examples of methods of forming fibers have been described herein. The fiber may be formed by a similar method to that used to form the first non-woven material layer, or may be formed by a different method. In some embodiments, the third composition is substantially similar to the second composition, and/or the second non-woven material layer may have a substantially similar chemical composition to the 3D-printed feature or other feature (e.g., a sprayed feature, an ink jetted feature, a valve jetted feature). In some embodiments, the third composition is identical to the first composition or includes one or more components included in the first composition. In some embodiments, the second non-woven material layer may have a substantially similar chemical make-up to the first non-woven material layer.

In some embodiments, a feature as described herein (e.g., a feature formed on a target, a feature formed on a non-woven material layer, an extruded feature, a sprayed feature, an ink jetted feature, a valve jetted feature) may have a variety of suitable designs. In some embodiments, the feature may substantially conform to the surface topology of the material on which it is disposed (e.g., a target, a non-woven material layer comprising deposited fibers). In some embodiments, a feature may substantially correspond to the surface topography of the material on which it is disposed, and the material on which it is disposed may be non-planar. Such features may be referred to as 2.5D features. FIG. 3D shows one non-limiting example of a 2.5D feature. In FIG. 3D, feature 20 substantially corresponds to the surface topography of material 10 on which it is disposed. Material 10 is curved, and feature 20 follows the curvature of material 10. The feature substantially corresponding to the surface topography of the material on which it is disposed (e.g., the 2.5D feature) may extend across the material on which it is disposed, or may only cover certain portions of the material on which it is disposed. These portions may be contiguous, or may be non-contiguous.

In some embodiments, a feature as described herein (e.g., a feature formed on a target, a feature formed on a non-woven material layer, an extruded feature, a sprayed feature, an ink jetted feature, a valve jetted feature) may not conform to the surface topology of the material on which it is disposed (e.g., a target, a non-woven material layer comprising deposited fibers). Such features may be referred to as 3D features. FIG. 3E shows one non-limiting example of a 3D feature. In FIG. 3E, feature 30 does not correspond to the surface topography of material 10 on which it is disposed. Material 10 is curved, and feature 20 has a different curvature than material 10. It should be understood that 3D features may also be formed on surfaces lacking curvature (e.g., planar surfaces). The 3D feature may extend across the material on which it is disposed, or may only cover certain portions of the material on which it is disposed. These portions may be contiguous, or may be non-contiguous.

In some embodiments, one or more properties of a feature as described herein (e.g., a feature formed on a target, a feature formed on a non-woven material layer, an extruded feature, a 3D-printed feature, a sprayed feature, an ink jetted feature, a valve jetted feature) may vary across the feature. For example, a region of a feature configured to be proximate a toe may have a lower stiffness than a region of the feature configured to be proximate the heel. In some embodiments, the property or properties of the feature may vary along a gradient across the feature, such as a smooth gradient. Non-limiting examples of types of gradients, properties that may vary along a gradient, and values of the properties along the gradient are described in U.S. patent application Ser. No. 15/907,160.

A feature (e.g., an extruded feature, a 3D-printed feature, a sprayed feature, an ink jetted feature, a valve jetted feature) may, in certain embodiments, may be configured to cure upon exposure to one or more triggers, such as UV light, heat, and/or moisture. In some embodiments, the feature may comprise one functional group configured to cure upon exposure to one type of trigger (e.g., UV light) and a second functional group configured to cure upon exposure to a second type of trigger (e.g., heat, moisture).

A 3D-printed feature, such as a 3D-printed feature formed by extrusion from a nozzle, may be any suitable feature. In some embodiments, the 3D-printed feature is one or more of a sole, an eyelet, a sensor, a heel counter, a heel cushion, a logo, a toe cap, a shank, an ankle support, a feature that limits the strain undergone by the non-woven article, a feature that is not sewn, and/or a no sew feature.

A 3D-printed feature, such as a 3D-printed feature formed by extrusion from a nozzle, may have any suitable dimensions. In some embodiments, one of the dimensions of the 3D-printed feature (e.g., a length, a width, a height) is greater than or equal to 50 microns, greater than or equal to 100 microns, greater than or equal to 200 microns, or greater than or equal to 500 microns. In some embodiments, one of the dimensions of the 3D-printed feature is less than or equal to 1 mm, less than or equal to 500 microns, less than or equal to 200 microns, or less than or equal to 100 microns. Combinations of the above-referenced ranges are also possible (e.g., greater than or equal to 50 microns and less than or equal to 1 mm). Other ranges are also possible.

3D-printed features, such as 3D-printed features formed by extrusion from a nozzle, if present, may have a variety of suitable microstructures. In some embodiments, the 3D-printed feature is a foam. The foam may be formed prior to 3D-printing (e.g., it may enter the 3D-printing nozzle as a foam), may form a foam while being 3D-printed (e.g., in the 3D-printing nozzle, while exiting the 3D-printing nozzle), and/or it may form a foam after 3D-printing (e.g., after exiting the 3D-printing nozzle). Non-limiting examples of suitable methods of forming foams include those described in U.S. patent application Ser. No. 15/907,128, incorporated herein in its entirety for all purposes. In some embodiments, the 3D-printed feature may be a type of material other than a foam (e.g., an elastomer, a material that is substantially non-porous).

A sprayed feature formed by a nozzle may have a variety of suitable thicknesses. The thickness of the sprayed feature may be greater than or equal to 30 microns, greater than or equal to 50 microns, greater than or equal to 100 microns, greater than or equal to 200 microns, greater than or equal to 500 microns, greater than or equal to 1 mm, greater than or equal to 2 mm, greater than or equal to 5 mm, greater than or equal to 1 cm, or greater than or equal to 2 cm. The thickness of the sprayed feature may be less than or equal to 5 cm, less than or equal to 2 cm, less than or equal to 1 cm, less than or equal to 5 mm, less than or equal to 2 mm, less than or equal to 1 mm, less than or equal to 500 microns, less than or equal to 200 microns, less than or equal to 100 microns, or less than or equal to 50 microns. Combinations of the above-referenced ranges are also possible (e.g., greater than or equal to 30 microns and less than or equal to 5 cm). Other ranges are also possible.

Sprayed features, if present, may have a variety of suitable microstructures. In some embodiments, the sprayed feature is a foam. The foam may be formed prior to spraying (e.g., it may enter the spray nozzle as a foam), may form a foam while being sprayed (e.g., in the spray nozzle, while exiting the spray nozzle), and/or it may form a foam after spraying (e.g., after exiting the spray nozzle). Non-limiting examples of suitable methods of forming foams include those described in U.S. patent application Ser. No. 15/907,128, incorporated herein in its entirety for all purposes. In some embodiments, the sprayed feature may be a type of material other than a foam (e.g., an elastomer, a material that is substantially non-porous).

Non-limiting examples of suitable materials that the sprayed features may comprise include polyurethanes, such as silane-terminated polyurethanes, and other materials that may be sprayed as described in U.S. patent application Ser. No. 15/907,128.

The sprayed features described herein (e.g., features formed on a target, features formed on a non-woven material layer) may cure prior to spraying (e.g., prior to entering the spray nozzle), may cure during spraying (e.g., while in the spray nozzle, while exiting the spray nozzle), and/or may cure after spraying (e.g., after exiting the spray nozzle. The sprayed material may not be fully cured prior to spraying, during spraying, and/or after spraying.

An ink jetted feature may have a variety of suitable designs. In some embodiments, an ink jetted feature may be colored, patterned, form an image, and/or have a design that is aesthetically pleasing. The ink jetted feature may comprise a pigment and/or a polymer. Ink jetted features and their compositions may include those described in U.S. Provisional Patent Application No. 62/619,989, incorporated herein in its entirety for all purposes. The ink jetted feature may be formed on and/or may penetrate into another layer (e.g., a non-woven material layer, an extruded layer, a sprayed layer). An article comprising the ink jetted feature may comprise an additional layer disposed on the ink jetted feature (e.g., an extruded layer, a sprayed layer). In some such embodiments, the layer positioned above the ink jetted feature may be translucent.

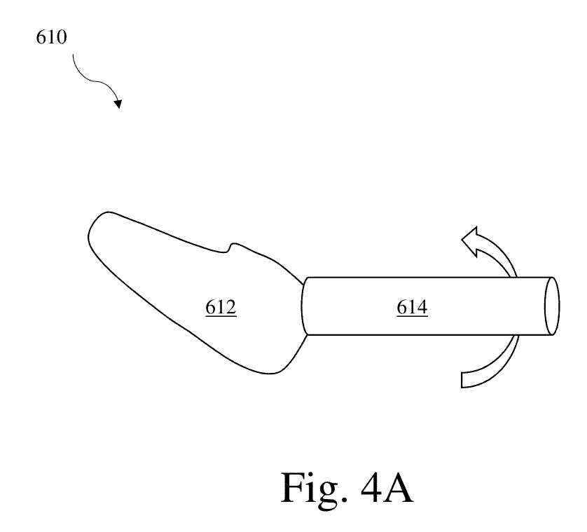

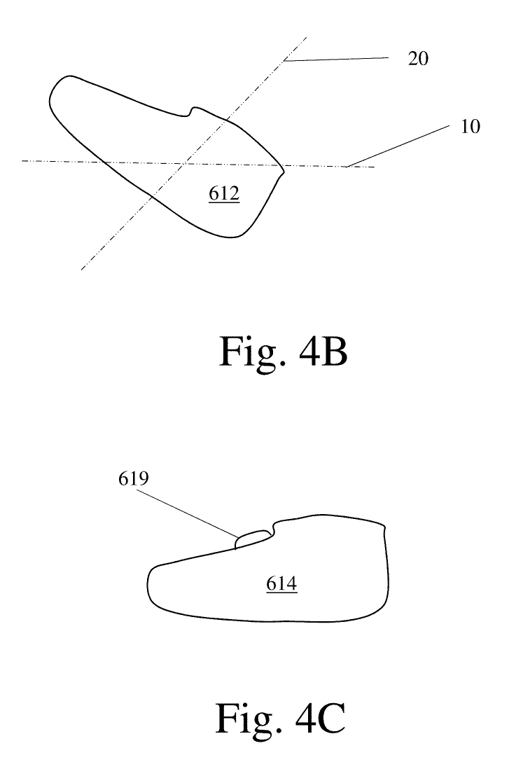

As described above, certain embodiments relate to targets such as footwear or other lasts with one or more features that can be used to facilitate the formation of non-woven materials with desirable properties for various articles. For example, in some embodiments, a last may be capable of rotating around an axis, e.g., at various speeds. As shown in FIG. 4A, footwear last 610 may comprise body portion 612 and axle 614 attached to the body portion. In some embodiments, the body portion may have a shape substantially corresponding to a shape of a human foot. The axle may be capable of rotating the body portion at varying speeds, which may affect the orientation at which fibers are deposited onto the body portion, the diameter of the fibers that are deposited onto the body portion, and/or the shape of the fibers that are deposited onto the body portion. It should be understood that although a footwear last is discussed here, this is by way of example only, and in other embodiments, other targets or lasts may be used, e.g., lasts to form other body parts (e.g., a hand, a knee, an elbow, or the like), or for other applications

In some embodiments, a footwear last may be rotated so as to pull one or more fibers onto the last by, for example, spinning the last quickly. Pulling fibers onto the last may result in the formation of a non-woven material comprising highly aligned fibers, which may enhance the strength of the non-woven material. In some embodiments, the axle may be capable of translating the body portion in one, two, or three dimensions.

In some embodiments, a footwear last may comprise a body portion (e.g., a portion with a shape substantially corresponding to a shape of a human foot) that can be stably rotated around at least a first axis and a second axis separate from the first axis. In FIG. 4B, body portion 612 may be stably rotated about first axis 10 and about second axis 20. In some embodiments, the first axis may intersect the second axis, and/or one or both of the first axis and the second axis may pass through the body portion. As used herein, stable rotation refers to rotation in which significant bending forces (e.g., significant bending forces applied by the body portion due to weight imbalance) are not applied to the axle. A footwear last comprising two or more stable axes may have these benefits when rotated at at least two different orientations, and so it may be possible to easily deposit fibers onto the last in at least two different orientations, to form non-woven materials comprising fibers oriented at at least two different orientations disposed on the last, or the like.

In embodiments in which a footwear last comprises a body portion (e.g., a body portion with a shape substantially corresponding to a shape of a human foot) that can be stably rotated around at least a first axis and a second axis that intersect, the angle between the first axis and the second axis may be any suitable value. In some embodiments, the angle is greater than or equal to 10°, greater than or equal to 30°, greater than or equal to 45°, greater than or equal to 60°, greater than or equal to 90°, greater than or equal to 120°, greater than or equal to 135°, or greater than or equal to 150°. In some embodiments, the angle is less than or equal to 180°, less than or equal to 150°, less than or equal to 135°, less than or equal to 120°, less than or equal to 90°, less than or equal to 60°, less than or equal to 45°, or less than or equal to 30°. Combinations of the above-referenced ranges are also possible (e.g., greater than or equal to 10° and less than or equal to 180°, or greater than or equal to 45° and less than or equal to 90°). Other ranges are also possible.

In some embodiments, a footwear last includes a body structure that comprises one or more protrusions that extend from the body structure. FIG. 4C shows one non-limiting embodiment of a body structure 614 comprising protrusion 619. It should be appreciated that the shape of protrusion 619 is exemplary, and that the protrusion may in some embodiments have a different shape than that shown in FIG. 4C. In some embodiments, a body structure may comprise a protrusion with a dimension (e.g., a length, a width, a height) with a size on the order of a dimension of the body portion (e.g., a length of the body portion, a width of the body portion, a height of the body portion). In some embodiments, the protrusion may have a shape that promotes the formation of a desirable feature in a non-woven material formed on the body structure. For example, the protrusion may have a shape that causes a non-woven material formed on the body structure to have an extended portion, such as a curled tongue, a fold-over toe cap, a heel counter, a toe box, or a wraparound feature. In some cases, such portions may be curled, folded, etc., into the final product.

In some embodiments, one or more articles as described herein (e.g., an article such as footwear, a non-woven material, a last such as a footwear last, or the like) may be disposed on a piece of fabric, or may be adjacent to a piece of fabric. For example, a non-woven material may be disposed on a piece of fabric, and/or a piece of fabric may be disposed on a footwear last or a body portion thereof. In some embodiments, one or more methods may comprise depositing one or more fibers onto a piece of and/or directly onto a piece of fabric, such as a piece of fabric disposed on a target such as a footwear last. The fabric may be, for example, a knit fabric or a non-woven fabric, and may have any suitable shape and size. In some embodiments, for example, the fabric is a sock. The fabric may have one or more beneficial properties, such as enhancing the comfort of a non-woven material disposed on the fabric. In some embodiments, the fabric may comprise an adhesive, and/or may be sprayed with an adhesive in order to provide additional stiffness and resistance to deformation during formation of a non-woven material on the fabric. The adhesive may be sprayed onto the fabric before fiber deposition and/or during fiber deposition.

In some embodiments, an article (e.g., a non-woven material; an article comprising a non-woven material and a feature disposed on the non-woven material, such as a 3D-printed feature, a sprayed feature, a valve jetted feature, and/or an ink jetted feature) as described herein may be removed from a target such as a last. For instance, the article (e.g., non-woven material; article comprising a non-woven material and a feature disposed on the non-woven material, such as a 3D-printed feature, a sprayed feature, a valve jetted feature, and/or an ink jetted feature) may be cut from the last, such as with a multi-axis laser cutter. Other methods, including manual cutting or physical cutting (for example, with suitable blades such as sawblades or scissors) may also be used in some embodiments.

In some embodiments, an article (e.g., a non-woven material; an article comprising a non-woven material and a feature disposed on the non-woven material, such as a 3D-printed feature, a sprayed feature, a valve jetted feature, and/or an ink jetted feature) as described herein may be laser etched.

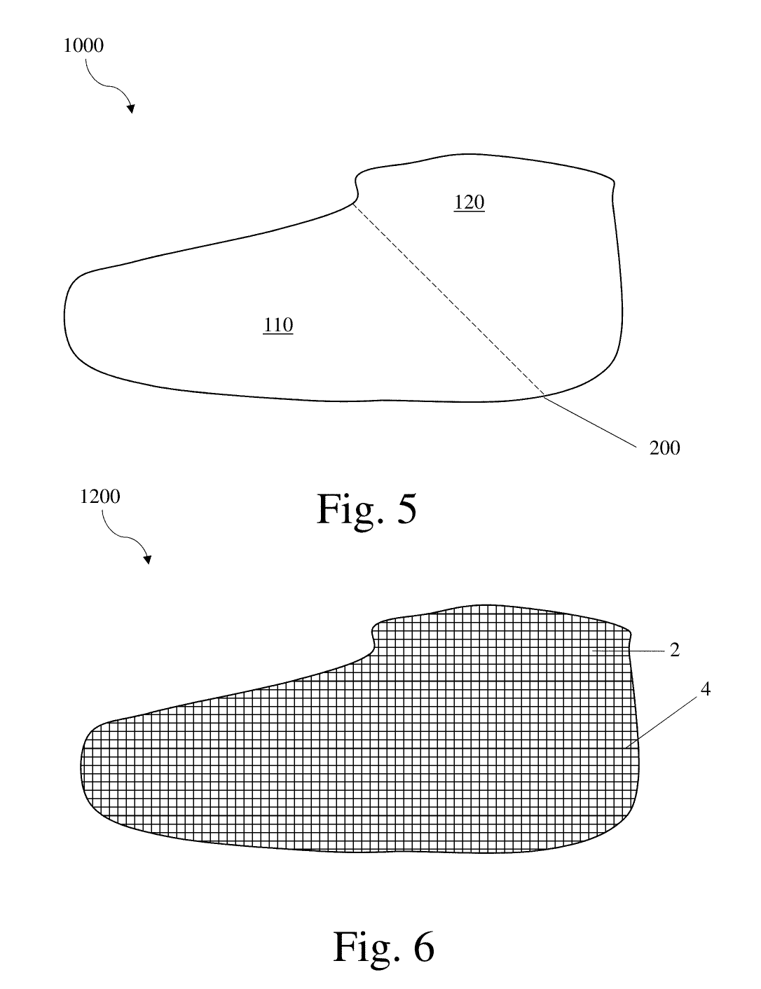

As described above, certain embodiments relate to articles formed from relatively few pieces of non-woven materials. In some embodiments, an article may be include less than five pieces of non-woven material, less than four pieces of non-woven material, less than three pieces of non-woven material, or less than two pieces of non-woven material. FIG. 5 shows one non-limiting embodiment of an article 1000 having a first piece of fabric 110 and second piece of fabric 120 joined together by seam 200. In some embodiments, as described above, the non-woven material may be formed from one piece of fabric, and/or may include short seams or few seams. Therefore, it should be understood that in some embodiments, the non-woven fabric may include a different number of pieces of fabric than shown in FIG. 5 and/or pieces of fabric with different shapes than those shown in FIG. 5. The seam(s) may also differ from those shown in FIG. 5; for instance, the seam(s) may be absent, or have a different length, shape, or position than those shown in FIG. 5. In some embodiments, the article may be a single integrated material.

In some embodiments, a non-woven material (e.g., as part of an article) may be flat. In other embodiments, a non-woven material may have a substantially non-planar shape, such as a shape that substantially corresponds to a shape of a human foot. The human foot may be a human foot of an adult, a child, a male, or a female. In some embodiments, the non-woven material may have a shape that substantially corresponds to a standard shoe size or a standard sock size. In some embodiments, the non-woven material comprises one or more individual protrusions for receiving individual toe(s) (in some cases, two or more toes may share a single protrusion). In other embodiments, there may be no protrusions (e.g., the toes are kept together), or there may be holes to allow one or more toes to exit (e.g., to extend out of the non-woven material).

In some embodiments, a non-woven material may comprise fibers disposed with respect to each other at an orientation that is advantageous. For example, in some embodiments the non-woven material may comprise fibers that are biaxially aligned, e.g., including a first group of fibers having a first angle and a second group of fibers having a second angle different from the first angle. As mentioned, the groups of fibers may cross at any suitable angle. FIG. 6 shows one example of a non-woven material 1200 comprising fibers 2 aligned in a first direction and fibers 4 aligned in a second direction. It should be understood that the directions shown are exemplary, and that the fibers may be aligned in different directions and/or intersect in different angles than those shown in FIG. 6. In some embodiments, a non-woven materials may comprise fibers that are uniaxially aligned (e.g., all fibers are along a single direction), triaxially aligned (e.g., comprising at least three groups of fibers, each of which are oriented along a different direction), and/or aligned in a different manner.

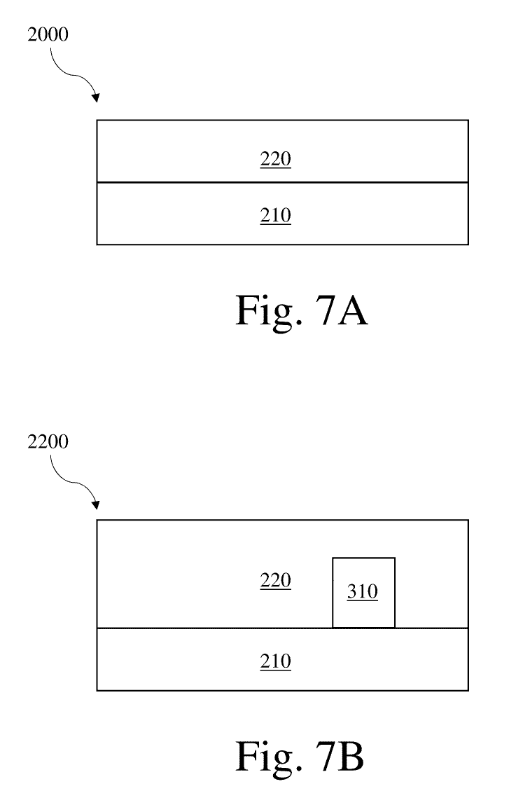

In some embodiments, a non-woven material may comprise more than one layer. For instance, the non-woven material may comprise at least a first layer and a second layer. FIG. 7A shows one non-limiting example of a non-woven material 2000 comprising second layer 220 disposed on first layer 210. It should be understood that FIG. 7A is exemplary, and that other shapes of the first layer and second layer and positions of the first layer with respect to the second layer are also possible. For example, in certain embodiments the first layer is positioned concentrically around the second layer and/or may cover the first layer, such as in the case of a non-woven material that is non-planar. It should also be understood that in some embodiments a non-woven material may comprise more than two layers, such as three layers, four layers, or more layers. In some embodiments, both the first layer and the second layer may together form a single piece of fabric. In some embodiments, the first layer and the second layer may one or more properties that are the same or different, such as the same or different chemical make-up, fiber diameter, fiber length, and/or thickness.

In some embodiments, a non-woven material may comprise at least a first layer and a second layer, and at least a portion of the fibers in the first layer may have a different alignment than at least a portion of the fibers in the second layer. For instance, a portion of the second layer comprising a fibers at a second orientation may be disposed on a portion of a first layer comprising fibers at a first orientation that is different than the second orientation. For example, a first layer may comprise fibers that are oriented along a direction that connects a heel portion of the non-woven material to a toe portion of the non-woven material and a second layer may comprise fibers that are oriented at a 60° angle to the fibers in the first layer and/or along a direction that connects a sole portion of the non-woven material to a laces portion of the non-woven material.

In some embodiments, in which a non-woven material comprises several layers of fibers (e.g. two layers, three layers, four layers, more layers) which are oriented in different directions and/or have different properties, the layers may cause scattering of incident light such that the non-woven material appears foggy.

In some embodiments, a non-woven material may comprise at least two layers, and one or more features may be positioned between two layers. FIG. 7B shows one non-limiting embodiment of a non-woven material 2200 comprising first layer 210, second layer 220, and feature 310. The feature may have any suitable geometry. In some embodiments, such as that shown in FIG. 7B, the feature does not cover the entirety of the interface between the first layer and the second layer. That is, the portions of the first layer are directly adjacent to the second layer and portions of the first layer are separated from the second layer by the feature. In other embodiments, the first layer may be completely separated from the second layer by the feature. In some embodiments, more than one feature may be positioned between the first layer and the second layer. Non-limiting examples of suitable features include sensors, electronics components, eyelets, heel counters, toe caps, shanks, ankle supports, logos, features that limit the strain undergone by the non-woven article, heel cushions, features that are not sewn, and/or no sew features.

The feature(s) may be 3D-printed features, or may be features formed by other techniques such as spraying, ink jetting, valve jetting, injection molding, compression molding, and/or stereolithography. In some embodiments, a 3D-printed feature or a non-3D-printed feature may be adhered to the non-woven material by an adhesive deposited by a 3D-printing technique (or other technique). Non-limiting examples of suitable adhesives include one-part adhesives, two-part adhesives, water-based adhesives, UV-curable adhesives, hot melt adhesives, moisture curing adhesives, and heat-curable adhesives (e.g., one-part heat-curable adhesives).

In some embodiments, a non-woven material may comprise a feature, such as a 3D-printed feature, with a dimension (e.g., a length, a width, a height) of greater than or equal to 0.5 mm, greater than or equal to 1 mm, greater than or equal to 2 mm, greater than or equal to 5 mm, greater than or equal to 10 mm, greater than or equal to 1 cm, greater than or equal to 2 cm, greater than or equal to 5 cm, greater than or equal to 10 cm, or greater than or equal to 20 cm. In some embodiments, a non-woven material may comprise a feature with a dimension of less than or equal to the length of the non-woven material, less than or equal to 20 cm, less than or equal to 10 cm, less than or equal to 5 cm, less than or equal to 2 cm, less than or equal to 1 cm, less than or equal to 10 mm, less than or equal to 5 mm, less than or equal to 2 mm, or less than or equal to 1 mm. Combinations of the above-referenced ranges are also possible (e.g., greater than or equal to 0.5 mm and less than or equal to the length of the non-woven material). Other ranges are also possible.

In some embodiments, a non-woven material may comprise one or more fibers that have advantageous properties. For example, the non-woven material may comprise one or more fibers that are chemically bonded together, such as by covalent bonds. The presence and type of chemical bonds between fibers may be determined by Fourier transform infrared spectroscopy. In some cases, the fibers cannot be separated without the breaking of those covalent bonds (e.g., chemically and/or physically). In some embodiments, the fibers that are chemically bonded together may comprise a thermoset polymer, and the bonding between the fibers may be the same type of bonding as within the bulk of the fiber. Suitable materials for fibers such as thermosets include polyurethanes, polyureas, epoxies, silicones, acrylates, methacrylates, and silanes.

In some embodiments, a non-woven material may comprise one or more continuous fibers, or fibers with a length of greater than or equal to 0.025 m, greater than or equal to 0.05 m, greater than or equal to 0.075 m, greater than or equal to 0.1 m, greater than or equal to 0.25 m, greater than or equal to 0.5 m, greater than or equal to 0.75 m, or greater than or equal to 1 m. In some embodiments, a non-woven material may comprise one or more fibers with a length of less than or equal to 2.5 m, less than or equal to 1 m, less than or equal to 0.75 m, less than or equal to 0.5 m, less than or equal to 0.25 m, less than or equal to 0.1 m, less than or equal to 0.075 m, or less than or equal to 0.05 m. Combinations of the above-referenced ranges are also possible (e.g., greater than or equal to 0.025 m and less than or equal to 2.5 m). Other ranges are also possible.

In some embodiments, an average length of the fibers in a non-woven material may be greater than or equal to 0.2 m, greater than or equal to 0.5 m, greater than or equal to 0.75 m, greater than or equal to 1 m, greater than or equal to 2 m, greater than or equal to 5 m, greater than or equal to 7.5 m, or greater than or equal to 10 m. In some embodiments, the average length of the fibers in the non-woven material may be less than or equal to 20 m, less than or equal to 10 m, less than or equal to 7.5 m, less than or equal to 5 m, less than or equal to 2 m, less than or equal to 1 m, less than or equal to 0.75 m, or less than or equal to 0.5 m. Combinations of the above-referenced ranges are also possible (e.g., greater than or equal to 0.2 m and less than or equal to 20 m). Other ranges are also possible.

In some embodiments, a non-woven material may further comprise a binder. Suitable types of binders include one-part adhesives, two-part adhesives, water-based adhesives, UV-curable adhesives, hot melt adhesives, moisture curing adhesives, and heat-curable adhesives (e.g., one-part heat-curable adhesives). In some embodiments, the binder makes up greater than or equal to 0.1 wt % of the non-woven material, greater than or equal to 0.2 wt % of the non-woven material, greater than or equal to 0.5 wt % of the non-woven material, greater than or equal to 1 wt % of the non-woven material, greater than or equal to 2 wt % of the non-woven material, greater than or equal to 5 wt % of the non-woven material, greater than or equal to 10 wt % of the non-woven material, or greater than or equal to 20 wt % of the non-woven material. In some embodiments, the binder makes up less than or equal to 50 wt % of the non-woven material, less than or equal to 20 wt % of the non-woven material, less than or equal to 10 wt % of the non-woven material, less than or equal to 5 wt % of the non-woven material, less than or equal to 2 wt % of the non-woven material, less than or equal to 1 wt % of the non-woven material, less than or equal to 0.5 wt % of the non-woven material, or less than or equal to 0.2 wt % of the non-woven material. Combinations of the above-referenced ranges are also possible (e.g., greater than or equal to 0.1 wt % and less than or equal to 50 wt % of the non-woven material). Other ranges are also possible.

A non-woven material may have any suitable thickness. In some embodiments, the thickness of the non-woven material is greater than or equal to 0.05 mm, greater than or equal to 0.1 mm, greater than or equal to 0.2 mm, greater than or equal to 0.5 mm, greater than or equal to 1 mm, or greater than or equal to 2 mm. In some embodiments, the thickness of the non-woven material is less than or equal to 5 mm, less than or equal to 2 mm, less than or equal to 1 mm, less than or equal to 0.5 mm, less than or equal to 0.2 mm, or less than or equal to 0.1 mm. Combinations of the above-referenced ranges are also possible (e.g., greater than or equal to 0.05 mm and less than or equal to 5 mm). Other ranges are also possible.

In some embodiments, one or more properties of a non-woven material may vary across the non-woven material. For example, in some embodiments the stiffness and/or the color of the non-woven material may vary with position in the non-woven material.

### EXAMPLE 1

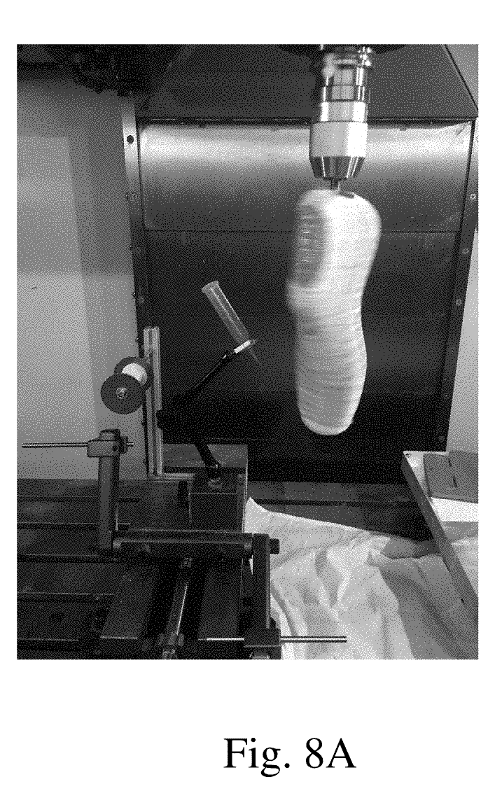

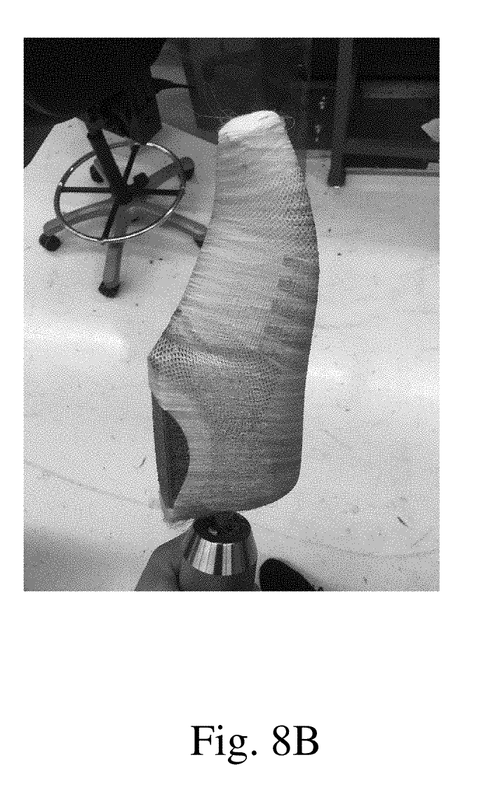

In this Example, a non-woven material is formed by depositing a pre-formed fiber onto a footwear last. The pre-formed fiber is passed through an adhesive and deposited onto the footwear last, as shown in FIGS. 8A-B. FIG. 8A shows the pre-formed fiber passing through a polyurethane adhesive with a molecular weight of 2000 Da and depositing onto the footwear last; FIG. 8B shows an example of a non-woven material formed from by the process depicted in FIG. 8A.

### EXAMPLE 2

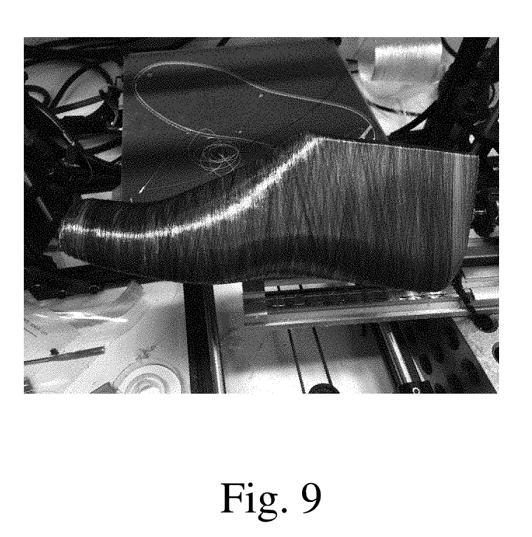

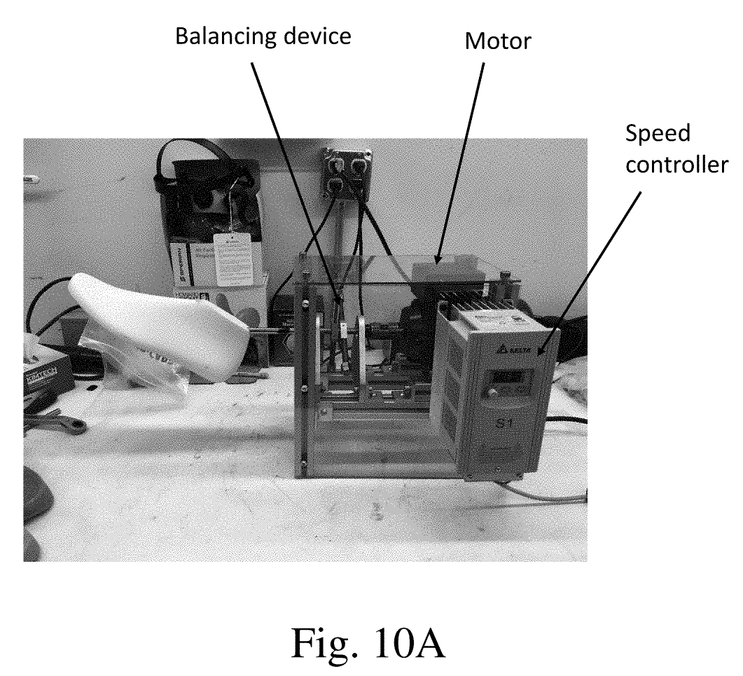

This Example shows a non-woven material formed by a melt spinning process. FIG. 9 shows a photograph of a non-woven material formed from a thermoplastic polyurethane fiber formed by a melt spinning process.

### EXAMPLE 3

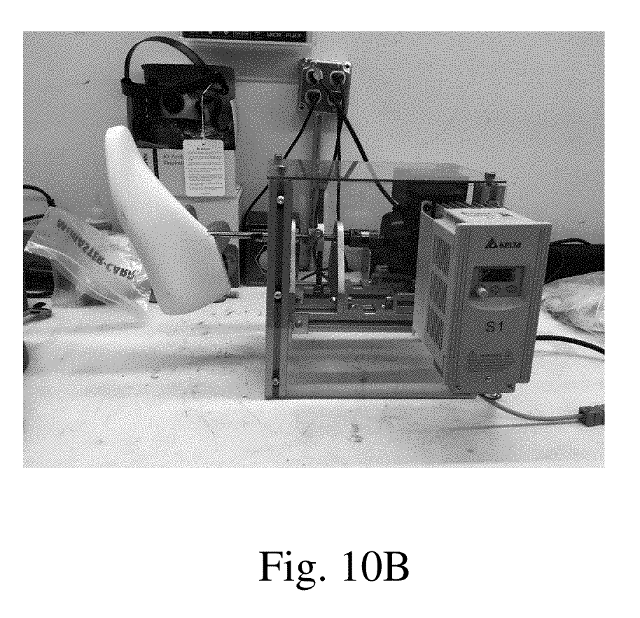

In this Example, a body portion of a footwear last is stably rotated around a first axis and stably around a second axis separate from the first axis. FIG. 10A shows the body portion oriented for rotation around the first axis, and FIG. 10B shows the body portion oriented for rotation around the second axis. The body portion of the footwear last is attached to a motor by an axle which is also attached to a balancing device. The speed of rotation may be controlled by a speed controller.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When the word “about” is used herein in reference to a number, it should be understood that still another embodiment of the invention includes that number not modified by the presence of the word “about.”

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A footwear article, comprising:
a non-woven material comprising thermoset fibers, at least a portion of the thermoset fibers being chemically bonded together, wherein the non-woven material consists of less than five pieces of fabric joined together by seams to form the non-woven material.

2. The article of claim 1, wherein the non-woven material is seamless.

3. The article of claim 1, wherein at least one of the five pieces comprises fibers that are biaxially aligned.

4-180. (canceled)

181. A method of forming an article, comprising:
extruding a composition from a nozzle, wherein the composition comprises at least a first species comprising a first functional group and a second species comprising a second functional group, and wherein the first functional group is reactive with the second functional group;
forming a fiber comprising a reaction product of the first species and the second species; and
depositing the fiber onto a target to form a non-woven material.

182. The method of claim 181, further comprising translating the nozzle with respect to the target while depositing the fiber onto the target to form the non-woven material.

183. The method of claim 181, further comprising translating the target with respect to the nozzle while depositing the fiber onto the target to form the non-woven material.

184-187. (canceled)

188. The method of claim 181, further comprising varying an angle at which the fiber is deposited while depositing the fiber onto the target to form the non-woven material.

189-193. (canceled)

194. The method of claim 181, further comprising curing at least a portion of the composition before extruding the composition from the nozzle.

195. The method of claim 181, further comprising curing at least a portion of the composition after depositing the fiber onto the target to form the non-woven material.

196. The method of claim 181, wherein at least a portion of the composition is uncured after depositing the fiber onto the target to form the non-woven material.

197. (canceled)

198. The method of claim 181, further comprising rotating the target.

199-211. (canceled)

212. The method of claim 181, further comprising extruding a feature on the non-woven material.

213-221. (canceled)

222. The method of claim 181, further comprising spraying a feature on the non-woven material.

223-231. (canceled)

232. The method of claim 181, further comprising forming a 3D-printed feature on the non-woven material.

233-251. (canceled)

252. The method of claim 181, further comprising forming an ink-jetted feature on the non-woven material.

253-257. (canceled)

258. The method of claim 181, wherein the reaction product comprises at least a portion of the first species and at least a portion of the second species.

259. The method of claim 181, wherein at least one of the first species and the second species is not incorporated into the reaction product.

260-268. (canceled)

269. A method of forming an article, comprising:
forming a fiber by extruding a first composition from a nozzle;
depositing the fiber onto a target to form a non-woven material; and
forming a 3D-printed feature on the non-woven material by 3D-printing a second composition from the nozzle.

270. (canceled)

271. The method of claim 269, wherein forming the fiber comprises melt spinning.

272-273. (canceled)

274. The method of claim 269, wherein forming the fiber comprises extruding a reactive composition.

275-330. (canceled)
